(19) United States
(12) Patent Application Publication
(10) Pub. No.: US 2012/0255271 A1
(43) Pub. Date: Oct. 11, 2012

(54) FRUIT PICKING DEVICE

(76) Inventor: Mohsen MADANI, Richmond Hill (CA)

(21) Appl. No.: 12/882,356

(22) Filed: Sep. 15, 2010

(51) Int. Cl. A01D 46/247

(52) U.S. Cl. 56/333

(57) ABSTRACT

A fruit picking device for picking fruits from a tree is provided. The fruit picking device includes an elongated rod defining a first end and a second end, a lower jaw detachably attached to the first end of the elongated rod, and an upper jaw attached to the lower jaw through a first pivot. The upper jaw is movable between a first position and a second position about the first pivot. The lower jaw and the upper jaw are configured to grab a fruit. The fruit picking device also includes one or more blades configured to cut the stem of the fruit. These blades are attached to at least one of: the lower jaw or the upper jaw. In addition, the fruit picking device includes a slider attached to the upper jaw. The movement of the slider in a predefined direction moves the upper jaw from the first position to the second position.

### FIELD OF INVENTION

The present invention relates, in general, to picking devices. More particularly, the present invention relates to fruit picking devices suitable for picking fruits from a tree.

### BACKGROUND

Fruits like apples and oranges grow on tall trees, and are difficult to pick by hand. In the past, gardeners have used step ladders to manually pick fruits from a tree. However, using a step ladder is often very tedious and time-consuming. In order to make the task of fruit harvesting easier for gardeners, various types of fruit picking devices have been devised in the past. A conventional fruit picking device includes an elongated rod to which a hook-like structure is attached. A gardener may, for example, place the hook-like structure near the stem of a fruit and pull the elongated rod to detach the fruit. The use of such a fruit picking device often detaches the stem from the fruit so picked. Consequently, the fruit may not be kept fresh for a long duration. Moreover, the fruit so picked falls directly on the ground or a container. This causes substantial damage to the fruit. Other conventional fruit picking devices are either relatively complicated in design or difficult to use.

In light of the foregoing discussion, there is a need for a fruit picking device that retains the stem of fruits picked, and is easy to use and carry.

### SUMMARY

An object of the present invention is to provide a fruit picking device for picking fruits from a tree.

Another object of the present invention is to provide a fruit picking device that retains the stem of the fruits picked.

Yet another object of the present invention is to provide a fruit picking device that is easy to use and carry.

Embodiments herein provide a fruit picking device for picking fruits from a tree. The fruit picking device includes an elongated rod defining a first end and a second end, a lower jaw detachably attached to the first end of the elongated rod, and an upper jaw attached to the lower jaw through a first pivot. The upper jaw is movable between a first position and a second position about the first pivot. The lower jaw and the upper jaw are configured to grab a fruit.

In accordance with an embodiment herein, the upper jaw has a substantially hemispherical shape. This allows a user to easily approach and grab a fruit between the lower jaw and the upper jaw.

The fruit picking device also includes one or more blades configured to cut the stem of the fruit. These blades are attached to at least one of: the lower jaw or the upper jaw. For example, these blades may cut the stem when the lower jaw and the upper jaw are closed together in a rapid movement. In this way, the stem of the fruit is retained.

In addition, the fruit picking device includes a slider attached to the upper jaw. The movement of the slider in a predefined direction moves the upper jaw from the first position to the second position. In an embodiment herein, the slider is a string. In another embodiment herein, the slider is a rod.

In accordance with an embodiment herein, the upper jaw includes one or more extended portions attached to the slider. These extended portions facilitate a smooth arcuate movement of the upper jaw.

In accordance with an embodiment herein, the fruit picking device includes a spring attached between the lower jaw and the upper jaw. The spring is configured to move the upper jaw from the second position to the first position.

In accordance with an embodiment herein, the fruit picking device includes a handle detachably attached to the second end of the elongated rod. In addition, the fruit picking device includes a lever attached to the handle through a second pivot, in accordance with an embodiment herein. The lever is configured to move the slider in the predefined direction.

In accordance with an embodiment herein, the fruit picking device includes a receiving net detachably attached to the lower jaw. The receiving net is configured to receive the fruit after the stem is cut.

In accordance with an embodiment herein, the elongated rod is hollow. In accordance with a specific embodiment herein, the elongated rod includes one or more coaxial hollow rods configured to adjust the length of the elongated rod.

The lower jaw and the upper jaw may, for example, be made from at least one of: plastic, fiber glass, wood, and metal. In addition, the blades may, for example, be made from at least one of: plastic, fiber glass, wood, and metal.

In an embodiment herein, various components of the fruit picking device are made from a light weight material, such as plastic. This makes the fruit picking device light in weight, and therefore, easy to use and carry.

Further, the handle may, for example, be designed ergonomically so as to make the fruit picking device easy to use and carry.

### BRIEF DESCRIPTION OF DRAWINGS

Embodiments herein will hereinafter be described in conjunction with the appended drawings provided to illustrate and not to limit the scope of the claims, wherein like designations denote like elements, and in which:

FIG. 1 depicts a fruit picking device, in accordance with an embodiment herein;

FIGS. 2A and 2B are side views of a lower jaw and an upper jaw, in accordance with an exemplary embodiment herein;

FIGS. 3A and 3B are top views of the lower jaw and the upper jaw, in accordance with an exemplary embodiment herein;

FIGS. 4A and 4B are front views of the lower jaw and the upper jaw, in accordance with an exemplary embodiment herein;

FIGS. 5A and 5B are perspective views of the lower jaw and the upper jaw, in accordance with an exemplary embodiment herein;

FIGS. 6A and 6B are perspective views of the lower jaw and the upper jaw, in accordance with an exemplary embodiment herein;

FIGS. 7A and 7B depict the telescopic rod, in accordance with a specific embodiment herein;

FIG. 8 illustrates the ergonomic handle, in accordance with an exemplary embodiment herein.

### DETAILED DESCRIPTION

As used in the specification and claims, the singular forms “a”, “an” and “the” include plural references unless the context clearly dictates otherwise. For example, the term “a fruit” may include a plurality of fruits unless the context clearly dictates otherwise.

Embodiments herein provide a fruit picking device for picking one or more fruits from a tree. In the description of the embodiments herein, numerous specific details are provided, such as examples of components and/or mechanisms, to provide a thorough understanding of embodiments herein. One skilled in the relevant art will recognize, however, that an embodiment herein can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments herein.

The fruit picking device includes an elongated rod defining a first end and a second end, a lower jaw detachably attached to the first end of the elongated rod, and an upper jaw attached to the lower jaw through a first pivot. The upper jaw is movable between a first position and a second position about the first pivot. The lower jaw and the upper jaw are configured to grab a fruit.

In accordance with an embodiment herein, the lower jaw has a substantially circular cross-sectional shape, while the upper jaw has a substantially hemispherical shape. This allows a user to easily approach and grab a fruit between the lower jaw and the upper jaw.

The fruit picking device also includes one or more blades configured to cut the stem of the fruit. These blades are attached to at least one of: the lower jaw or the upper jaw. For example, these blades may cut the stem when the lower jaw and the upper jaw are closed together in a rapid movement.

In addition, the fruit picking device includes a slider attached to the upper jaw. The movement of the slider in a predefined direction moves the upper jaw from the first position to the second position. In an embodiment herein, the slider is a string. In another embodiment herein, the slider is a rod.

In accordance with an embodiment herein, the upper jaw includes one or more extended portions attached to the slider. These extended portions facilitate a smooth arcuate movement of the upper jaw.

In accordance with an embodiment herein, the fruit picking device includes a spring attached between the lower jaw and the upper jaw. The spring is configured to move the upper jaw from the second position to the first position.

In accordance with an embodiment herein, the fruit picking device includes a handle detachably attached to the second end of the elongated rod. In addition, the fruit picking device includes a lever attached to the handle through a second pivot, in accordance with an embodiment herein. The lever is configured to move the slider in the predefined direction.

In accordance with an embodiment herein, the fruit picking device includes a receiving net detachably attached to the lower jaw. The receiving net is configured to receive the fruit after the stem is cut.

In accordance with an embodiment herein, the elongated rod is hollow. In accordance with a specific embodiment herein, the elongated rod includes one or more coaxial hollow rods configured to adjust the length of the elongated rod.

The lower jaw and the upper jaw may, for example, be made from at least one of: plastic, fiber glass, wood, and metal. In addition, the blades may, for example, be made from at least one of: plastic, fiber glass, wood, and metal.

In an embodiment herein, various components of the fruit picking device are made from a light weight material, such as plastic. This makes the fruit picking device light in weight, and therefore, easy to use and carry.

Further, the handle may, for example, be designed ergonomically so as to make the fruit picking device easy to use and carry.

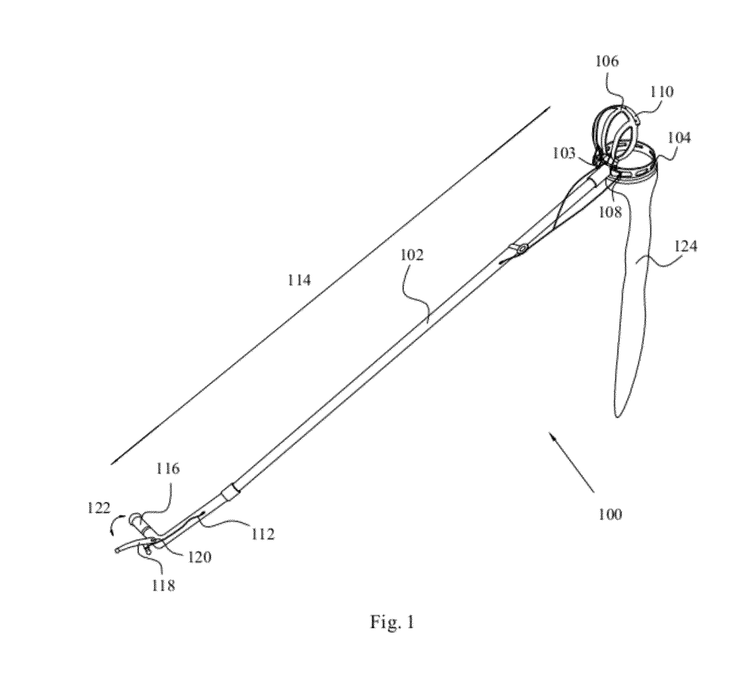

Referring now to figures, FIG. 1 depicts a fruit picking device 100 suitable for picking one or more fruits from a tree, in accordance with an embodiment herein. Fruit picking device 100 includes an elongated rod 102 defining a first end and a second end, a lower jaw 104 detachably attached to the first end of elongated rod 102, and an upper jaw 106 attached to lower jaw 104 through a first pivot 108. Upper jaw 106 is movable between a first position and a second position about first pivot 108. Lower jaw 104 and upper jaw 106 are configured to grab a fruit.

Lower jaw 104 and upper jaw 106 may have any desired shape. In accordance with an embodiment herein, lower jaw 104 has a substantially circular cross-sectional shape, while upper jaw 106 has a substantially hemispherical shape. This allows a user to easily approach and grab a fruit between lower jaw 104 and upper jaw 106.

Fruit picking device 100 also includes one or more blades, shown as a blade 110, configured to cut the stem of the fruit. These blades may be attached to at least one of: lower jaw 104 or upper jaw 106. With reference to FIG. 1, blade 110 is attached to upper jaw 106. Blade 110 may, for example, cut the stem when lower jaw 104 and upper jaw 106 are closed together in a rapid movement.

In addition, fruit picking device 100 includes a slider 112 attached to upper jaw 106. The movement of slider 112 in a predefined direction moves upper jaw 106 from the first position to the second position. For example, slider 112 may be moved along a longitudinal axis 114, as shown in FIG. 1.

In accordance with an embodiment herein, upper jaw 106 includes one or more extended portions attached to slider 112. These extended portions facilitate a smooth arcuate movement of upper jaw 106.

In accordance with an embodiment herein, fruit picking device 100 includes a spring 103 attached between lower jaw 104 and upper jaw 106. The spring 103 is configured to move upper jaw 106 from the second position to the first position.

In accordance with an embodiment herein, fruit picking device 100 includes a handle 116 detachably attached to the second end of elongated rod 102. In addition, fruit picking device 100 includes a lever 118 attached to handle 116 through a second pivot 120, in accordance with an embodiment herein. Lever 118 is configured to move slider 112 in the predefined direction. For example, lever 118 may be moved along arrow 122 about second pivot 120 to move slider 112 along longitudinal axis 114, as shown in FIG. 1.

In an embodiment herein, slider 112 is a string. For example, one end of the string may be attached to the extended portions of upper jaw 106, while the other end of the string may be attached to lever 118. When lever 118 is pressed, the string is pulled towards handle 116 along longitudinal axis 114. Consequently, upper jaw 106 moves from the first position to the second position.

In another embodiment herein, slider 112 is a rod. For example, one end of the rod may be attached to the extended portions of upper jaw 106, while the other end of the rod may be attached to lever 118. When lever 118 is pressed, the rod is pulled towards handle 116 along longitudinal axis 114. Consequently, upper jaw 106 moves from the first position to the second position.

Consider, for example, that the first position of upper jaw 106 is an open position, while the second position of upper jaw 106 is a closed position with respect to lower jaw 104. In accordance with an embodiment herein, upper jaw 106 remains in the open position by default, as shown in FIG. 1. A fruit may, for example, be approached and grabbed between upper jaw 106 and lower jaw 104 in the first position. Thereafter, upper jaw 106 and lower jaw 104 may be closed together in the second position, whereby blade 110 may cut the stem of the fruit.

Upper jaw 106 and lower jaw 104 may, for example, be closed together in a rapid movement by pressing lever 118. Lever 118 may then be released. Consequently, the spring 103 may move upper jaw 106 back to the first position from the second position.

In another example, consider that the first position of upper jaw 106 is a closed position, while the second position of upper jaw 106 is an open position with respect to lower jaw 104. In accordance with another embodiment herein, upper jaw 106 remains in the closed position by default. A fruit may, for example, be approached, and lever 118 may be pressed to open upper jaw 106 for grabbing the fruit between upper jaw 106 and lower jaw 104 in the second position. Lever 118 may then be released. Consequently, the spring 103 may move upper jaw 106 back from the second position to the first position, whereby blade 110 may cut the stem of the fruit.

In accordance with an embodiment herein, fruit picking device 100 includes a receiving net 124 detachably attached to lower jaw 104. Receiving net 124 is configured to receive the fruit after the stem is cut.

In an embodiment herein, receiving net 124 is a closed net configured to hold the fruits so received. In another embodiment herein, receiving net 124 is an open net configured to transfer the fruits so received to a separate container.

In accordance with an embodiment herein, elongated rod 102 is hollow. In an embodiment herein, a hole is located near the first end of elongated rod 102. The string (that is, slider 112) passes into the hole, and extends through the inner side of elongated rod 102 towards the second end of elongated rod 102, where handle 116 is attached.

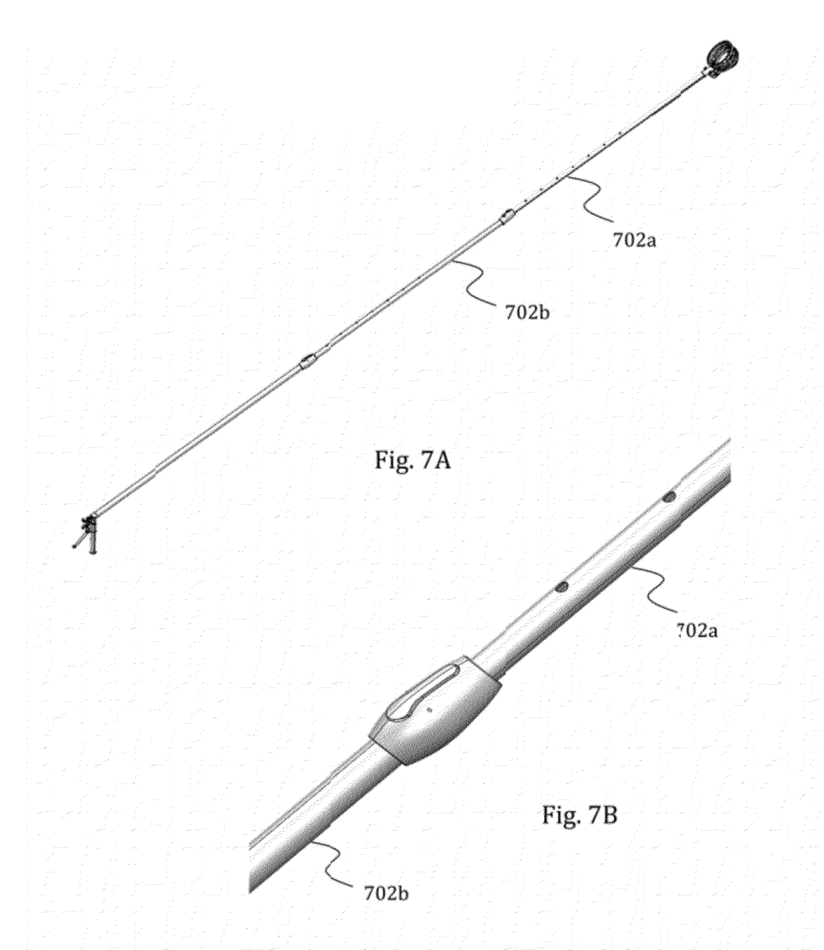

As lower jaw 104 and handle 116 are detachably attached to elongated rod 102, elongated rods of different lengths may be used, as required. In accordance with a specific embodiment herein, elongated rod 102 includes one or more coaxial hollow rods configured to adjust the length of elongated rod 102. Details of the coaxial hollow rods have been provided in conjunction with FIGS. 7A and 7B.

Lower jaw 104 and upper jaw 106 may, for example, be made from at least one of: plastic, fiber glass, wood, and metal. In addition, blade 110 may, for example, be made from at least one of: plastic, fiber glass, wood, and metal.

In an embodiment herein, various components of fruit picking device 100 are made from a light weight material, such as plastic. This makes fruit picking device 100 light in weight, and therefore, easy to use and carry.

Further, handle 116 may, for example, be designed ergonomically so as to make fruit picking device 100 easy to use and carry. A detailed design of an ergonomic handle of the present invention is provided in FIG. 9.

It should be noted here that fruit picking device 100 is not limited to a specific shape or size of its components. FIG. 1 is merely an example, which should not unduly limit the scope of the claims herein. One of ordinary skill in the art would recognize many variations, alternatives, and modifications of embodiments herein.

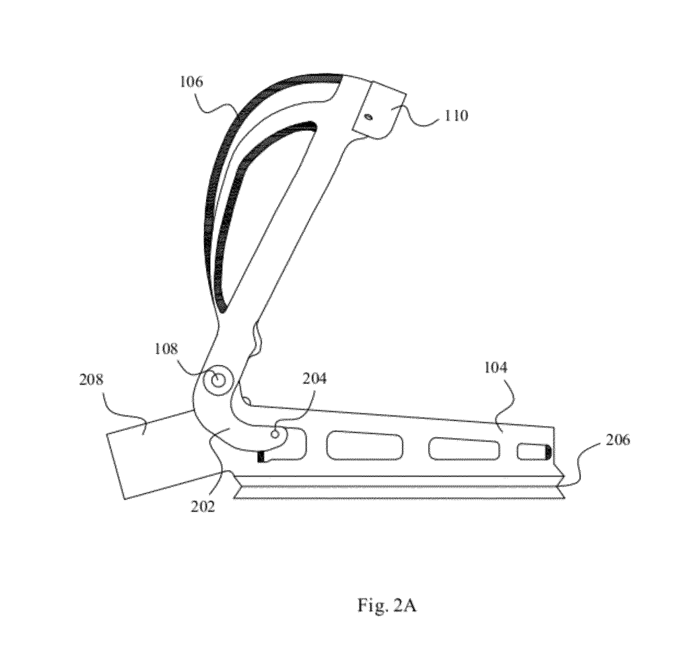

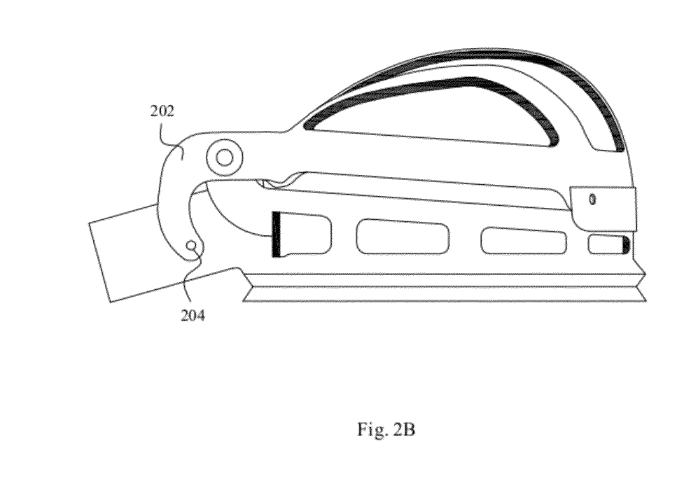

FIGS. 2A and 2B are side views of lower jaw 104 and upper jaw 106, in accordance with an exemplary embodiment herein. FIG. 2A depicts an open position of upper jaw 106 with respect to lower jaw 104, while FIG. 2B depicts a closed position of upper jaw 106 with respect to lower jaw 104. With reference to FIGS. 2A and 2B, the extended portions of upper jaw 106 have been shown as extended portions 202. Extended portions 202 include a hole 204 through which slider 112 could be attached. The movement of slider 112 along longitudinal axis 114 moves extended portions 202 from one position to another, as depicted in FIGS. 2A and 2B. Consequently, upper jaw 106 moves in a smooth arcuate fashion about first pivot 108.

In accordance with an embodiment herein, lower jaw 104 includes a bend 206 configured to attach receiving net 124 to lower jaw 104. Bend 206 may be made angular or curved in shape, as desired. With reference to FIG. 2A, bend 206 is angular in shape.

In addition, lower jaw 104 includes a portion 208 configured to attach lower jaw 104 to the first end of elongated rod 102.

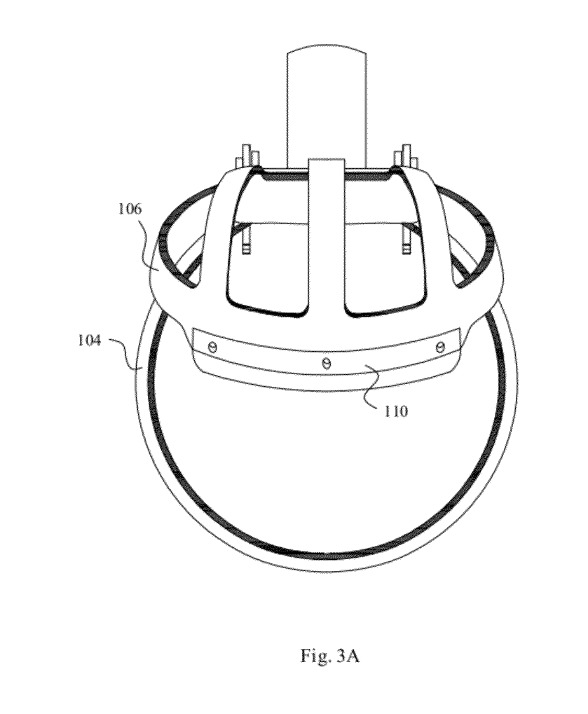

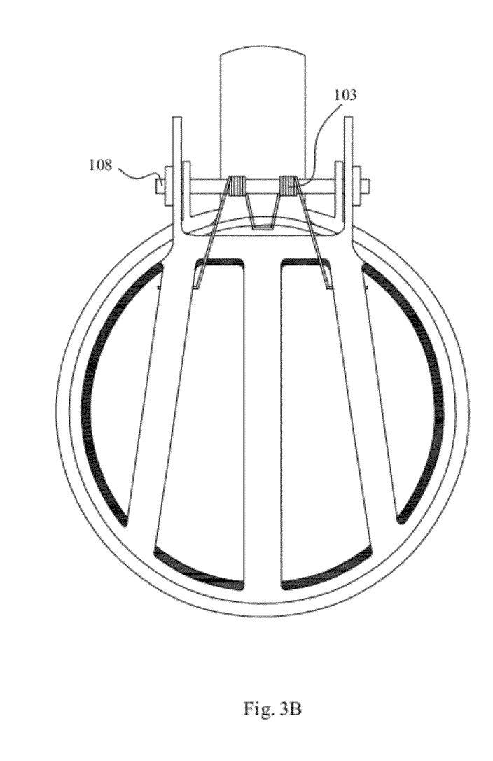

FIGS. 3A and 3B are top views of lower jaw 104 and upper jaw 106, in accordance with an exemplary embodiment herein. FIG. 3A depicts an open position of upper jaw 106 with respect to lower jaw 104, while FIG. 3B depicts a closed position of upper jaw 106 with respect to lower jaw 104.

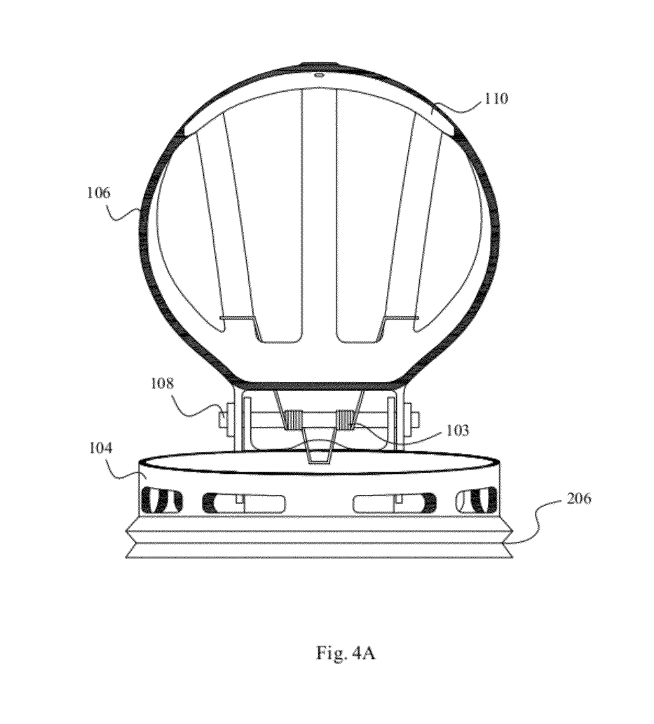

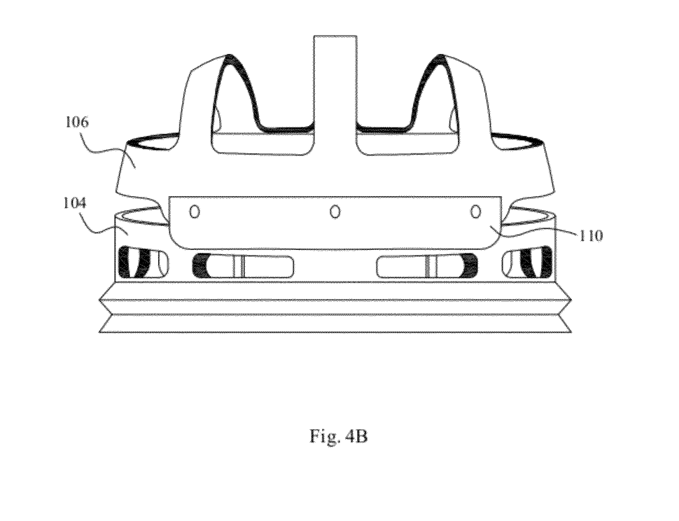

FIGS. 4A and 4B are front views of lower jaw 104 and upper jaw 106, in accordance with an exemplary embodiment herein. FIG. 4A depicts an open position of upper jaw 106 with respect to lower jaw 104, while FIG. 4B depicts a closed position of upper jaw 106 with respect to lower jaw 104.

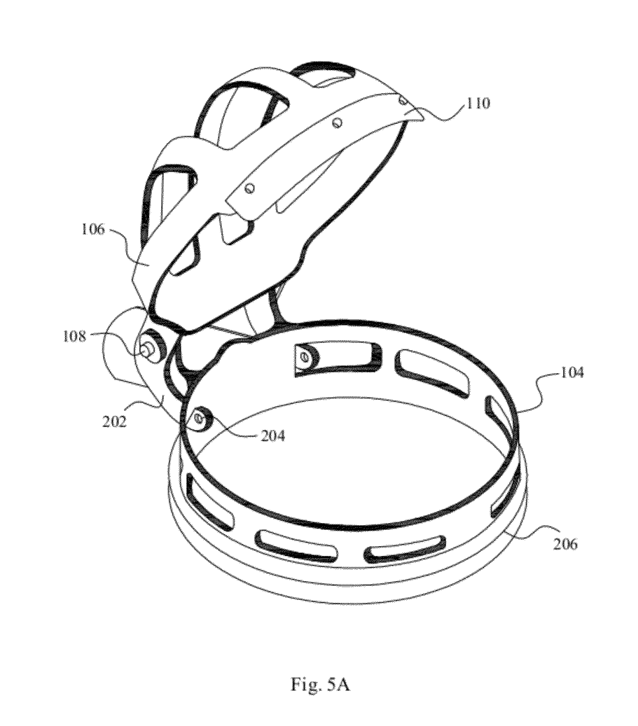

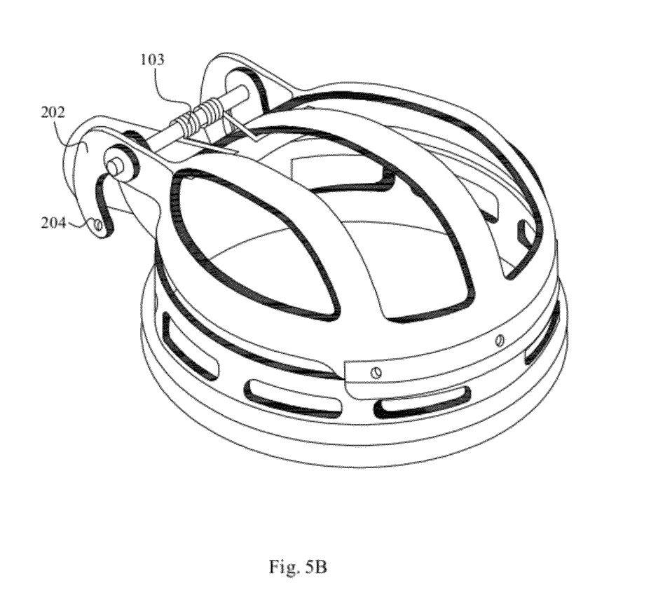

FIGS. 5A and 5B are perspective views of lower jaw 104 and upper jaw 106, in accordance with an exemplary embodiment herein. FIG. 5A depicts an open position of upper jaw 106 with respect to lower jaw 104, while FIG. 5B depicts a closed position of upper jaw 106 with respect to lower jaw 104.

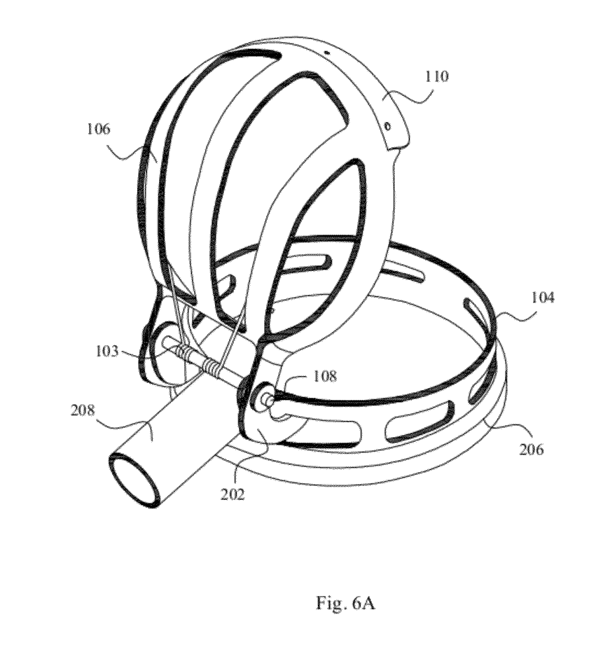

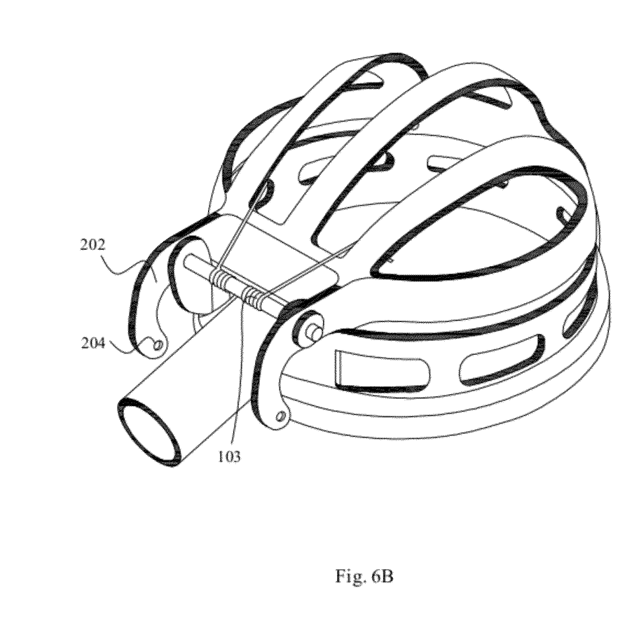

FIGS. 6A and 6B are perspective views of lower jaw 104 and upper jaw 106, in accordance with an exemplary embodiment herein. FIG. 6A depicts an open position of upper jaw 106 with respect to lower jaw 104, while FIG. 6B depicts a closed position of upper jaw 106 with respect to lower jaw 104.

With reference to FIGS. 2A-B, 3A-B, 4A-B, 5A-B and 6A-B, lower jaw 104 has a substantially circular cross-sectional shape, while upper jaw 106 has a substantially hemispherical shape.

Lower jaw 104 and upper jaw 106 may have any desired shape. In an embodiment herein, lower jaw 104 and upper jaw 106 may include a plurality of supporting ribs in their structure. With reference to FIGS. 2A-B, 3A-B, 4A-B, 5A-B and 6A-B, lower jaw 104 includes seven ribs, while upper jaw 106 includes three ribs. These ribs make lower jaw 104 and upper jaw 106 shock-resistant and robust. In addition, the ribs of upper jaw 106 facilitate enhanced visibility to a user who is trying to pick a fruit on a tree.

It should be noted that lower jaw 104 and upper jaw 106 are not limited to a specific shape or size. For example, upper jaw 106 may be in the form of a cylindrical cup, in an alternative embodiment herein.

With reference to FIG. 6A, portion 208 of lower jaw 104 has a circular cross-sectional shape. Accordingly, elongated rod 102 may also have a circular cross-sectional shape. It should be noted that elongated rod 102 and portion 208 may have any desired shape. For example, the cross-sectional shapes of elongated rod 102 and portion 208 may be elliptical, square, rectangular, triangular and the like.

FIGS. 2A-B, 3A-B, 4A-B, 5A-B and 6A-B are merely an example, which should not unduly limit the scope of the claims herein. One of ordinary skill in the art would recognize many variations, alternatives, and modifications of embodiments herein.

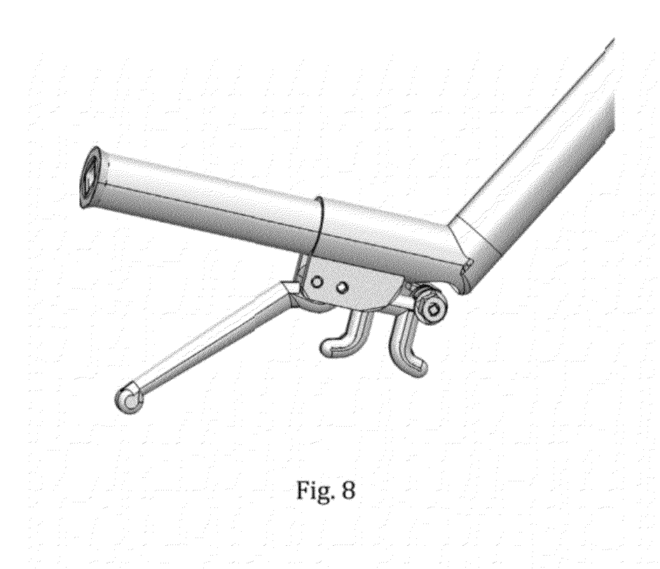

FIGS. 7A and 7B depict a portion of elongated rod 102, in accordance with a specific embodiment herein. With reference to FIG. 7A, a hollow rod 702a is coaxially arranged within another hollow rod 702b. Hollow rod 702a may slide out from hollow rod 702b, as shown in FIG. 7B. In this way, hollow rod 702a may slide within or out from hollow rod 702b to adjust the length of elongated rod 102, as and when required. The telescopic rod of the present device is illustrated in FIG. 8A and 8B, in which the rod length can be adjusted easily.

An embodiment of the present invention provides an object picking device for picking one or more objects. The object picking device includes an elongated rod defining a first end and a second end, a lower jaw detachably attached to the first end of the elongated rod, and an upper jaw attached to the lower jaw through a first pivot. The upper jaw is movable between a first position and a second position about the first pivot. The lower jaw and the upper jaw are configured to grab an object.

In accordance with an embodiment herein, the lower jaw has a substantially circular cross-sectional shape, while the upper jaw has a substantially hemispherical shape. This allows a user to easily approach and grab an object between the lower jaw and the upper jaw.

The object picking device also includes one or more blades configured to detach the object. These blades are attached to at least one of: the lower jaw or the upper jaw. For example, these blades may detach the object when the lower jaw and the upper jaw are closed together in a rapid movement.

In addition, the object picking device includes a slider attached to the upper jaw. The movement of the slider in a predefined direction moves the upper jaw from the first position to the second position. In an embodiment herein, the slider is a string. In another embodiment herein, the slider is a rod.

In accordance with an embodiment herein, the upper jaw includes one or more extended portions attached to the slider. These extended portions facilitate a smooth arcuate movement of the upper jaw.

In accordance with an embodiment herein, the object picking device includes a spring attached between the lower jaw and the upper jaw. The spring 103 is configured to move the upper jaw from the second position to the first position.

In accordance with an embodiment herein, the object picking device includes a handle detachably attached to the second end of the elongated rod. In addition, the object picking device includes a lever attached to the handle through a second pivot, in accordance with an embodiment herein. The lever is configured to move the slider in the predefined direction.

In accordance with an embodiment herein, the object picking device includes a receiving net detachably attached to the lower jaw. The receiving net is configured to receive the object.

In accordance with an embodiment herein, the elongated rod is hollow. In accordance with a specific embodiment herein, the elongated rod includes one or more coaxial hollow rods configured to adjust the length of the elongated rod.

The lower jaw and the upper jaw may, for example, be made from at least one of: plastic, fiber glass, wood, and metal. In addition, the blades may, for example, be made from at least one of: plastic, fiber glass, wood, and metal.

In an embodiment herein, various components of the object picking device are made from a light weight material, such as plastic. This makes the object picking device light in weight, and therefore, easy to use and carry.

Further, the handle may, for example, be designed ergonomically so as to make the object picking device easy to use and carry.

Furthermore, the object picking device may be used to access objects which are beyond the reach of a person. In one example, the object picking device may be used to pick objects placed on an elevated surface. In another example, the object picking device may be used to pick objects placed below a heavy piece of furniture, such as a dining table. In yet another example, the object picking device may be used to pick objects placed at a narrow area, such as behind a bed.

Embodiments herein provide a fruit picking device for picking fruits from a tree. The shape of the lower jaw and the upper jaw allows a user to easily approach and grab a fruit between the lower jaw and the upper jaw.

In addition, the fruit picking device includes blades configured to cut the stem of the fruit. The stem of the fruits so picked is retained. Consequently, the fruits remain fresh for longer duration.

Moreover, the fruit picking device may be configured to reach fruits at different heights, by adjusting the length of the elongated rod. Therefore, the fruit picking device may be suitably used to pick various types of fruits, such as apples, pears, citrus fruits, and the like.

Further, various components of the fruit picking device may be made from light weight and durable materials. For example, the lower jaw, the upper jaw and the elongated rod may be made from plastic, while the blade may be made from a light weight metal, such as aluminum. This makes the fruit picking device light in weight, and therefore, easy to use and carry.

Furthermore, the handle may be designed ergonomically so as to make the fruit picking device easy to use and carry.

This application may disclose several numerical range limitations that support any range within the disclosed numerical ranges even though a precise range limitation is not stated verbatim in the specification because the embodiments of the invention could be practiced throughout the disclosed numerical ranges. Finally, the entire disclosure of the patents and publications referred in this application, if any, are hereby incorporated herein in entirety by reference.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A fruit picking device for picking one or more fruits from a tree, the fruit picking device comprising:
an elongated rod defining a first end and a second end;
a lower jaw detachably attached to the first end of the elongated rod;
an upper jaw attached to the lower jaw through a first pivot, the upper jaw being movable between a first position and a second position about the first pivot, wherein the lower jaw and the upper jaw are configured to grab the one or more fruits;
one or more blades configured to cut the stem of the one or more fruits, the one or more blades being attached to at least one of: the lower jaw and the upper jaw; and
a slider attached to the upper jaw, wherein the movement of the slider in a predefined direction moves the upper jaw from the first position to the second position.

2. The fruit picking device of claim 1, wherein the upper jaw comprises one or more extended portions attached to the slider, the one or more extended portions facilitate a smooth arcuate movement of the upper jaw.

3. The fruit picking device of claim 1 further comprising a spring attached between the lower jaw and the upper jaw, wherein the spring 103 is configured to move the upper jaw from the second position to the first position.

4. The fruit picking device of claim 1 further comprising a handle detachably attached to the second end of the elongated rod.

5. The fruit picking device of claim 4 further comprising a lever attached to the handle through a second pivot, wherein the lever is configured to move the slider in the predefined direction.

6. The fruit picking device of claim 1 further comprising a receiving net detachably attached to the lower jaw, wherein the receiving net is configured to receive the one or more fruits after the stem is cut.

7. The fruit picking device of claim 1, wherein the upper jaw is substantially hemispherical in shape.

8. The fruit picking device of claim 1, wherein the elongated rod is hollow.

9. The fruit picking device of claim 1, wherein the elongated rod comprises one or more coaxial hollow rods, the one or more coaxial hollow rods are configured to adjust the length of the elongated rod.

10. The fruit picking device of claim 1, wherein the slider is a string.

11. The fruit picking device of claim 1, wherein the slider is a rod.

12. The fruit picking device of claim 1, wherein the lower jaw and the upper jaw are made from at least one of: plastic, fiber glass, wood, and metal.

13. The fruit picking device of claim 1, wherein the one or more blades are made from at least one of: plastic, fiber glass, wood, and metal.

14. An object picking device for picking one or more objects, the object picking device comprising:
an elongated rod defining a first end and a second end;
a lower jaw detachably attached to the first end of the elongated rod;
an upper jaw attached to the lower jaw through a first pivot, the upper jaw being movable between a first position and a second position about the first pivot, wherein the lower jaw and the upper jaw are configured to grab the one or more objects;
one or more blades configured to detach the one or more objects, the one or more blades being attached to at least one of: the lower jaw and the upper jaw; and
a slider attached to the upper jaw, wherein the movement of the slider in a predefined direction moves the upper jaw from the first position to the second position.

15. The object picking device of claim 14, wherein the upper jaw comprises one or more extended portions attached to the slider, the one or more extended portions facilitate a smooth arcuate movement of the upper jaw.

16. The object picking device of claim 14 further comprising a spring attached between the lower jaw and the upper jaw, wherein the spring 103 is configured to move the upper jaw from the second position to the first position.

17. The object picking device of claim 14 further comprising a handle detachably attached to the second end of the elongated rod.

18. The object picking device of claim 17 further comprising a lever attached to the handle through a second pivot, wherein the lever is configured to move the slider in the predefined direction.

19. The object picking device of claim 14 further comprising a receiving net detachably attached to the lower jaw, wherein the receiving net is configured to receive the one or more objects.

20. The object picking device of claim 14, wherein the upper jaw is substantially hemispherical in shape.

21. The object picking device of claim 14, wherein the elongated rod is hollow.

22. The object picking device of claim 14, wherein the elongated rod comprises one or more coaxial hollow rods, the one or more coaxial hollow rods are configured to adjust the length of the elongated rod.

23. The object picking device of claim 14, wherein the slider is a string.

24. The object picking device of claim 14, wherein the slider is a rod.

25. The object picking device of claim 14, wherein the lower jaw and the upper jaw are made from at least one of: plastic, fiber glass, wood, and metal.

26. The object picking device of claim 14, wherein the one or more blades are made from at least one of: plastic, fiber glass, wood, and metal.
